(19) United States
(12) Patent Application Publication
(10) Pub. No.: US 2026/0217211 A1
(43) Pub. Date: Jul. 30, 2026

(54) AIRBAG MODULE

(71) Applicant: iSi Automotive Holding GmbH, Wien (AT)

(72) Inventor: Detlef Crohn, Berlin (DE)

(21) Appl. No.: 19/456,122

(22) Filed: Jan. 22, 2026

(30) Foreign Application Priority Data
Jan. 28, 2025 (DE) 20 2025 100 412.7

(51) Int. Cl. B60R 21/26; B60R 21/235

(52) U.S. Cl. CPC B60R 21/26; B60R 21/235; B60R 2021/23504; B60R 2021/26076

(57) ABSTRACT

An airbag module for a motor vehicle includes an airbag and a tubular gas generator. A fastening bolt is arranged on the tubular gas generator. The airbag includes at least one airbag wall that forms a self-contained space for receiving gas. The airbag wall includes a gas generator inlet opening and a securing tab for securing the securing tab to the fastening bolt. The tubular gas generator is at least partially inserted into the airbag via the gas generator inlet opening such that a gas generator outlet protrudes into the airbag. In an accident situation, the airbag is inflatable by a gas flowing out of the tubular gas generator. The securing tab is at least partially folded transversely or obliquely to a longitudinal axis of the tubular gas generator and in a direction of the fastening bolt, and is secured by a securing opening to the bolt.

### RELATED APPLICATION AND PRIORITY CLAIM

This application is related to and claims priority to German Utility Model Application No. 20 2025 100 412.7, filed on Jan. 28, 2025, and entitled “Airbagmodul”, which is hereby incorporated by reference in its entirety.

### FIELD OF THE INVENTION

The present invention relates to an airbag module, in particular for a motor vehicle, and to an airbag of such an airbag module.

### BACKGROUND

It is known that tubular gas generators for filling airbags, for example in the case of a side airbag or central area airbag, which airbags are arranged in a backrest region of a driver's and/or front passenger's seat, are at least partially arranged via a gas generator inlet opening in the airbag for filling it with a gas or a gas mixture, with, for installing the airbags on the seat, at least one fastening bolt conventionally being provided on the gas generator.

It is an object of the invention to create an airbag module which is easy to produce and is cost-effective and which ensures a retrospective installation of a gas generator in an already folded airbag, without the otherwise necessary opening and closing of a seam, with increased tightness, in particular in the region of a gas generator inlet opening, being ensured to ensure a high restraint effect of a vehicle occupant during an accident situation.

### SUMMARY

According to a first aspect of the invention, an airbag module is provided which comprises an airbag and at least one tubular gas generator having a longitudinal axis, on which tubular gas generator at least one fastening bolt, preferably in the form of a threaded bolt, for positioning the airbag module on a vehicle component is arranged. The airbag comprises at least one airbag wall, which airbag wall forms a self-contained space for receiving gas and has an inner wall surface and an outer wall surface. The airbag wall comprises at least one gas generator inlet opening and at least one securing tab, which at least one securing tab comprises at least one securing opening for securing the securing tab to the at least one fastening bolt. The tubular gas generator is at least partially inserted into the airbag via the gas generator inlet opening in such a way that at least one gas generator outlet of the tubular gas generator protrudes into the airbag so that, in an accident situation, the airbag is inflatable by means of a gas flowing out of the tubular gas generator.

According to first aspect, it is further provided that the securing tab is at least partially folded transversely or obliquely to the longitudinal axis of the tubular gas generator and in the direction of the at least one fastening bolt connected to the tubular gas generator, and is secured by its at least one securing opening to the at least one fastening bolt. It is thus provided that the securing tab is folded substantially perpendicularly or obliquely to the longitudinal axis of the gas generator in the direction of the fastening bolt or the fastening bolts and is thus folded back onto the gas generator counter to the push-in direction thereof. By means of such an arrangement of the securing tab, a retrospective installation of the gas generator in the already folded airbag is possible, as a result of which also a possible replacement of a gas generator can be realized and high process reliability is ensured, since the tubular gas generator, when arranged in the airbag, is covered only in the external region by the securing tab. In other words, by means of such an arrangement, a tubular gas generator which is at least partially arranged in the airbag can be removed from the airbag via the gas generator inlet opening even in the folded state of the airbag and re-used. The outer region of the gas generator is at least partially covered merely by the securing tab.

The fact that the securing tab is at least partially folded transversely or obliquely to the longitudinal axis of the tubular gas generator means that the folding line or folding seam along which the securing tab is folded does not necessarily extend at an angle of 90 degrees to the longitudinal axis of the tubular gas generator. For example, it extends at an angle to the longitudinal axis lying in the range of between 60 degrees and 120 degrees.

In detail, in the inserted state of the tubular gas generator, a sealing region is formed by such an arrangement of the securing tab in a region of the gas generator inlet opening by means of the outer wall surface of the airbag wall, since the securing tab and the outer wall surface of the airbag form an overlapping region and thus a sealing region, which completely encloses a region of a shell surface of the tubular gas generator.

The securing tab itself may be arranged on the outer wall surface of the airbag wall by means of a securing seam and/or by means of an adhesive connection, with alternative or optionally supplementary connection forms, for example a clamping connection or rivet connection, also being able to be realized.

In order to realize folding of the securing opening of the securing tab over the fastening bolt or insertion of the fastening bolt into the securing opening, the securing tab may be elongated, preferably tongue-shaped, with the at least one securing opening being arranged opposite the securing seam and/or the adhesive connection. This affords the advantage that no closing seam is required after the gas generator has been inserted into the gas generator inlet opening.

In this case, the at least one fastening bolt may be arranged via a clamp on the tubular gas generator, the latter, in an alternative embodiment, being welded on the tube of the tubular gas generator by means of a weld seam.

Also, in an embodiment, the airbag wall comprises at least one flame retardant layer on the inner wall surface in the region of the gas generator inlet opening, which flame retardant layer may be arranged on the inner wall surface of the airbag wall by means of the securing seam, with which the securing tab is also arranged on the airbag wall, and/or by means of an adhesive connection. By using the securing seam for arrangement of the flame retardant layer, at least one working step and additional material, for example in the form of a seam or an adhesive material, can thus be saved.

In addition, in an embodiment, the airbag wall comprises a connecting layer on the outer wall surface. The connecting layer may be configured to be arranged on the outer wall surface of the airbag wall by means of a connecting seam and/or an adhesive connection. The connecting seam and/or the adhesive connection are/is offset with respect to a longitudinal axis of the tubular gas generator, thus enabling the gas generator to be inserted into the airbag. In detail, the connecting layer serves to increase the load absorption and to correctly position the airbag on a vehicle structure or seat structure.

In an embodiment, the connecting layer is designed in such a way that it at least partially covers the tubular gas generator when the latter is inserted in the gas generator inlet opening, the connecting layer preferably comprising at least one bolt passage opening for receiving the at least one fastening bolt in the inserted state of the tubular gas generator in the gas generator inlet opening. By the at least one fastening bolt being received in the at least one bolt passage opening of the connecting layer, the latter acts in a load-bearing manner. In other words, the connecting layer can thereby absorb forces acting on the airbag, in particular during the deployment operation. In order to ensure the absorption of higher tensile forces, the at least one bolt passage opening is preferably reinforced by means of a fastening bolt seam.

In addition, in a further embodiment, in order to absorb higher tensile forces in the region of the gas generator inlet opening, the airbag wall comprises at least one reinforcing layer, which is arranged on the inner wall surface and/or outer wall surface, the reinforcing layer being arranged on the airbag wall by means of at least one reinforcing seam and/or an adhesive connection.

In an alternative embodiment, it is also conceivable to arrange a reinforcing layer on the inner wall surface and on the outer wall surface. The reinforcing layer when arranged on the inner wall surface serves as additional thermal protection as well as for absorbing tensile forces, whereas the reinforcing layer when arranged on the outer wall surface serves as protection against possible damage by the vehicle structure or seat structure as well as for absorbing tensile forces.

In another embodiment, the tubular gas generator comprises two fastening bolts, a first fastening bolt being arranged closer to the gas generator inlet opening than a second fastening bolt. In this case, the securing tab may be designed in such a way that the securing opening can be arranged on the first fastening bolt, and, in an alternative embodiment, the securing tab is elongated, e.g. obliquely or L-shaped, in such a way that the securing opening can be positioned on the second fastening bolt. It is also conceivable for the securing tab to comprise two securing openings, which can each be arranged on a fastening bolt.

In the case of a securing tab which is elongated, such as oblique or L-shaped, for arrangement on the second fastening bolt, the connecting layer is also accordingly longer. This ensures that the gas generator is rotated when inserted in the airbag. In detail, in this embodiment, the installation position of the gas generator can be rotated by 90 degrees, as a result of which a rotated arrangement of the gas generator, for example on a seat, can be realized. In other words, the rotational orientation of the bolts can be defined by means of the length of the connecting layer and the securing tab.

It should be noted at this point that the longitudinal axis (axes) of the fastening bolt(s) as well as the securing opening(s) and bolt passage opening(s) lie in a common intersecting plane of the gas generator when the latter is inserted in the airbag.

In another embodiment, in order to realize an even greater tightness of the airbag module, a sealing means for producing a gas-tight connection is arranged along the reinforcing seam between the reinforcing layer and the airbag wall and/or along the securing seam between the securing tab and the airbag wall and/or along the connecting seam between the connecting layer and the airbag wall.

In another embodiment, the airbag wall comprises, on the outer wall surface, at least one additional connecting layer, which is arranged along the longitudinal axis of the tubular gas generator parallel to the connecting layer. The additional connecting layer can be arranged on the outer wall surface of the airbag wall by means of an additional connecting seam and/or an adhesive connection. In detail, the additional connecting layer at least partially covers the securing tab in the inserted state of the tubular gas generator in the gas generator inlet opening, the additional connecting layer comprising at least one additional bolt passage opening for receiving the at least one fastening bolt in the inserted state of the tubular gas generator in the gas generator inlet opening, as a result of which an increased load absorption is ensured when the airbag module is deployed. The at least one additional bolt passage opening is preferably reinforced by means of an additional fastening bolt seam.

A further refinement of the invention provides that the gas generator inlet opening is at least partially covered by means of the securing tab in the uninserted state of the tubular gas generator. This permits a highly gastight sealing of the gas generator inlet opening by the securing tab and the formation of an effective sealing region.

In a further aspect, the present invention relates to an airbag. The airbag is for an airbag module which comprises the airbag and at least one tubular gas generator having a longitudinal axis and at least one fastening bolt. The airbag comprises at least one airbag wall, which airbag wall forms a self-contained space for receiving gas and comprises an inner wall surface and an outer wall surface, the airbag wall comprising at least one gas generator inlet opening and at least one securing tab, which at least one securing tab has at least one securing opening for securing the securing tab to a fastening bolt of a tubular gas generator. It is furthermore provided that the gas generator inlet opening is designed in such a way that a tubular gas generator can be at least partially inserted into the airbag via the gas generator inlet opening in such a way that at least one gas generator outlet of the tubular gas generator protrudes into the airbag, so that, in an accident situation, the airbag is inflatable by means of a gas flowing out of the tubular gas generator.

It is further provided that the securing tab is designed and arranged in such a way that it can be at least partially folded transversely or obliquely to the longitudinal axis of a tubular gas generator inserted into the gas generator inlet opening and in the direction of at least one fastening bolt connected to the tubular gas generator, and can be secured by its at least one securing opening to one such fastening bolt.

The airbag of the present invention corresponds to the airbag of the airbag module of the present invention. The embodiments of the airbag module as defined in the dependent claims also apply correspondingly to the airbag of the present invention.

In a further aspect, the present invention relates to a method for producing an airbag module. The method comprises the steps of:
introducing at least one gas generator outlet of a tubular gas generator into a gas generator inlet opening of an airbag wall which forms an inner wall surface and an outer wall surface;
partially folding a connecting layer fastened to the outer wall surface of the airbag wall about a longitudinal axis of the tubular gas generator;
inserting at least one fastening bolt connected to the tubular gas generator into a bolt passage opening of the connecting layer;
rotating the tubular gas generator about its longitudinal axis in such a way that the connecting layer is tensioned;
at least partially folding a securing tab fastened to the outer wall surface of the airbag wall transversely or obliquely to the longitudinal axis of the tubular gas generator in the direction of the at least one fastening bolt of the tubular gas generator; and
fastening a securing opening of the securing tab to the at least one fastening bolt.

In one embodiment, the securing tab is elongated, preferably is oblique or L-shaped, and the connecting layer is accordingly longer.

In a further refinement, it can be provided that, by rotating the tubular gas generator about the longitudinal axis, the installation position of the gas generator can be determined depending on the length of the connecting layer and the securing tab. The securing tab is only inserted after the rotation and thus also ensures the correct orientation of at least one fastening bolt and an insertion depth of the generator into the airbag.

If there is an additional connecting layer arranged parallel to the connecting layer, said additional connecting layer is then folded around the securing tab, and the at least one fastening bolt connected to the tubular gas generator is inserted into an additional bolt passage opening of the additional connecting layer such that the additional connecting layer at least partially encloses the securing tab, as a result of which an increased load absorption is ensured in the event of deployment of the airbag module.

### BRIEF DESCRIPTION OF THE DRAWINGS

For further explanation of the invention, reference is made in the following to the description of the drawings, from which further advantageous refinements, details and developments of the invention can be gathered. The drawings are provided to illustrate embodiments of the inventions described herein and not to limit the scope thereof.

FIG. 1 shows a longitudinal sectional view A-A of an embodiments of airbag module according to the invention in the unfolded state with an inserted gas generator according to FIG. 4;

FIG. 2 shows a front view of the airbag module according to the invention in the unfolded state without an inserted gas generator;

FIG. 3 shows a rear view of the airbag module according to the invention in the unfolded state without an inserted gas generator;

FIG. 4 shows a rear view of the airbag module according to the invention in the unfolded state with an inserted gas generator;

FIG. 5 shows a front perspective view of the airbag module according to the invention in the folded state with an inserted gas generator;

FIG. 6 shows a rear perspective view of the airbag module according to the invention in the folded state with an inserted gas generator;

FIG. 7 shows a front view of another embodiment of the airbag module according to the invention in the unfolded state without an inserted gas generator;

FIG. 8 shows a front view of another embodiment of the airbag module according to the invention in the unfolded state without an inserted gas generator;

FIG. 9 shows a front perspective view of the embodiment according to the invention of the airbag module according to the invention according to FIG. 7 in the folded state with an inserted gas generator;

FIG. 10 shows a rear perspective view of the embodiment according to the invention of the airbag module according to the invention according to FIG. 7 in the folded state with an inserted gas generator;

FIG. 11 shows a front view of another embodiment of the airbag module according to the invention in the unfolded state without an inserted gas generator;

FIG. 12 shows a front perspective view of the embodiment according to the invention of the airbag module according to the invention according to FIG. 11 in the folded state with an inserted gas generator;

FIG. 13 shows a rear perspective view of the embodiment according to the invention of the airbag module according to the invention according to FIG. 11 in the folded state with an inserted gas generator;

FIG. 14 shows a front perspective view of another embodiment according to the invention of the airbag module according to the invention in the folded state with an inserted gas generator;

FIG. 15 shows a rear perspective view of the embodiment according to the invention of the airbag module according to the invention according to FIG. 14 in the folded state with an inserted gas generator;

### DETAILED DESCRIPTION

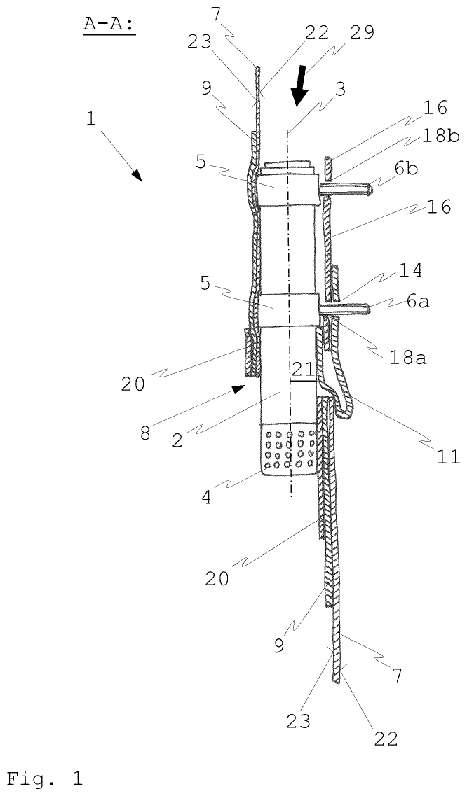

FIG. 1 shows a longitudinal sectional illustration A-A of an airbag module according to the invention in the unfolded state with a tubular gas generator 2 inserted in an airbag 1. In this case, the tubular gas generator 2 having a longitudinal axis 3 has two fastening bolts 6a, 6b, which are each arranged on the tubular gas generator 2 by means of a clamp 5, for the arrangement of the airbag module on a vehicle component. The airbag 1 comprises an airbag wall 7, which forms a self-contained space for receiving gas with an inner wall surface 23 and an outer wall surface 22, the airbag wall 7 comprising a gas generator inlet opening 8 and a securing tab 11, which is arranged on the outer wall surface 22 of the airbag wall 7 and has a securing opening 14 for securing the securing tab 11 to at least one of the fastening bolts 6a, 6b. The tubular gas generator 2 is inserted into the gas generator inlet opening 8 at least to an extent such that a gas generator outlet 4 of the tubular gas generator 2 protrudes into the airbag 1 so that, in an accident situation, the airbag 1 is inflatable by means of a gas or gas mixture flowing out of the tubular gas generator 2. In this case, a sealing region 21 is formed in the region of the gas generator inlet opening 8, as a result of which the gas or gas mixture flowing out of the tubular gas generator 2 can be prevented from flowing out of the airbag 1. In addition, a reinforcing layer 9 is arranged on the inner wall surface 23 of the airbag wall 7 in the region of the gas generator inlet opening 8, as a result of which the airbag 1, in the event of deployment in an accident situation, withstands higher pressure forces and tensile forces, in particular in the region of the gas generator inlet opening 8.

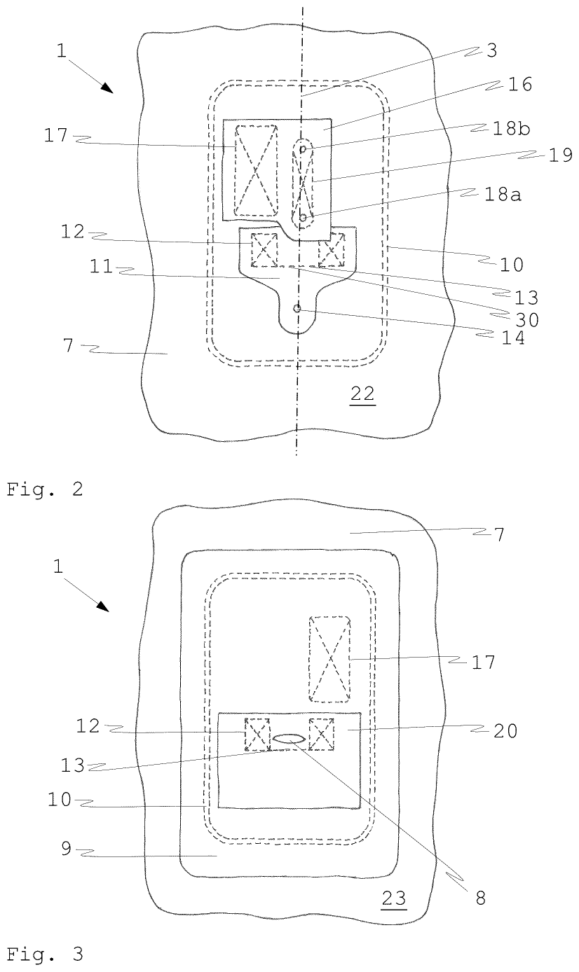

In addition, a connecting layer 16 is offset on the outer wall surface 22 of the airbag wall 7 with respect to the longitudinal axis 3 of the tubular gas generator 2, which connecting layer is arranged according to FIG. 2 by means of a connecting seam 17. In this case, the connecting layer 16 is designed in such a way that, when the tubular gas generator 2 is inserted in the gas generator inlet opening 8, said connecting layer at least partially covers said tubular gas generator and has two bolt passage openings 18a, 18b for receiving the fastening bolts 6a, 6b of the tubular gas generator 2 in the gas generator inlet opening 8. In addition, the airbag wall 7 has a flame retardant layer 20 on the inner wall surface 23 in the region of the gas generator inlet opening 8 for protection against a possible hot gas jet through the gas generator 2 when the latter is activated.

The gas generator 2 is to be inserted into the airbag 1 in the direction of the securing tab 11, i.e., in the present case, from the top downward, as a result of which a plug access 29 is also established.

FIG. 2 shows a front view of the airbag module according to the invention in the unfolded state without an inserted gas generator 2. In this case, the connecting seam 17, with which the connecting layer 16 is offset with respect to a longitudinal axis 3 of the tubular gas generator 2, is clearly visible. Also, in the embodiment illustrated, the bolt passage openings 18a, 18b are reinforced by means of a fastening bolt seam 19, as a result of which a higher tensile force is ensured when the gas generator 2 is activated in an accident situation. The securing tab 11 is arranged on the outer wall surface 22 of the airbag wall 7 by means of a securing seam 12. It is clearly apparent here in FIG. 2 that the securing seam 12 is C-shaped with a connecting web 13. This serves to ensure that there is still access to the gas generator inlet opening 8, which is covered by means of the securing tab 11. It should be noted at this point that it is also conceivable to reinforce the securing opening 14 of the securing tab 11 by means of a seam for absorbing higher forces.

It is noted that, in FIG. 2, a folding line 30 or folding edge for the securing tab 11, along which the movable, not securely stitched, part of the securing tab 11 is foldable, is formed by the C-shaped securing seam 12 with the connecting web 13. The folding line or folding edge 30 runs transversely (or alternatively obliquely) to the longitudinal axis 3 of the tubular gas generator 2 when the latter is inserted, so that the movable part of the securing tab 11 is foldable around the folding edge 30 and thus transversely (or alternatively obliquely) to the longitudinal axis 3 of the tubular gas generator 2 and in the direction of the fastening bolts 6a, 6b. The fastening bolt 6a, which lies closer to the gas generator inlet opening 8, is connected to the securing opening 14 of the securing tab 11, or the securing tab 11 is secured by its securing opening 14 to the fastening bolt 6a. As explained with reference to FIGS. 7-15, as an alternative, the securing opening 14 can be connected to the other fastening bolt 6b further away from the gas generator inlet opening 8, or two securing openings can be provided, each of which is connected to one of the two fastening bolts 6a, 6b.

Furthermore, it is pointed out that the shape and orientation of the securing seam 12 with the connecting web 13 should be understood as being merely by way of example. In principle, any securing seam shape may be provided which defines a folding edge allowing a part of the securing tab 11 to be folded transversely or obliquely to the longitudinal axis 3 of the tubular gas generator 2 and in the direction of the fastening bolts 6a, 6b. It may also be provided as an alternative in exemplary embodiments that the folding edge does not extend along the securing seam, but parallel to the securing seam.

FIG. 3 shows a rear view of the airbag module according to the invention in the unfolded state without an inserted gas generator 2. It is clearly evident that the reinforcing layer 9 is arranged on the inner wall surface 23 of the airbag wall 7 by means of a reinforcing seam 10. In this case, the flame retardant layer 20 and the airbag wall 7 have the gas generator inlet opening 8, the flame retardant layer 20 being arranged on the inner wall surface 23 of the airbag wall 7 by means of the securing seam 12 of the securing tab 11.

FIG. 4 shows a rear view of the airbag module according to the invention in the unfolded state with an inserted gas generator 2. It is clearly evident that only the gas generator outlet 4 of the tubular gas generator 2 protrudes into the airbag 1, as a result of which a possible replacement and subsequent installation and removal of the gas generator 2 can be realized.

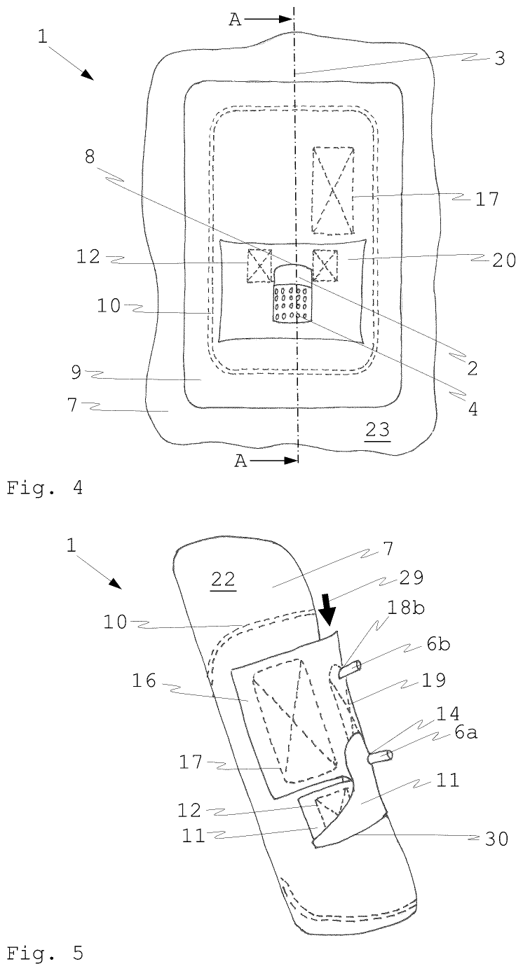

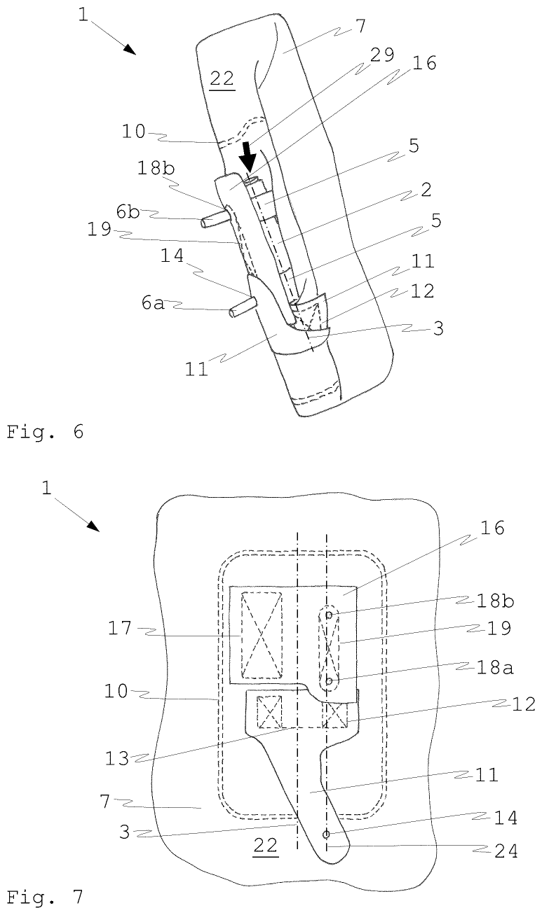

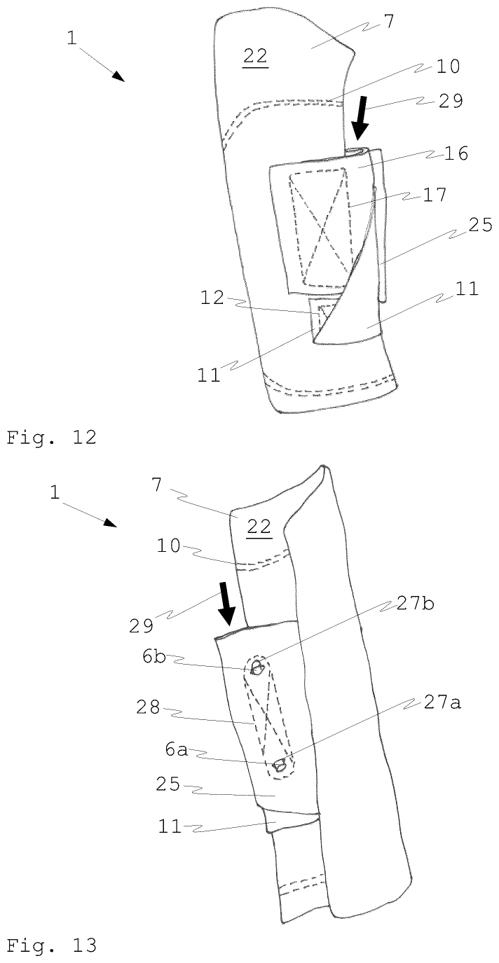

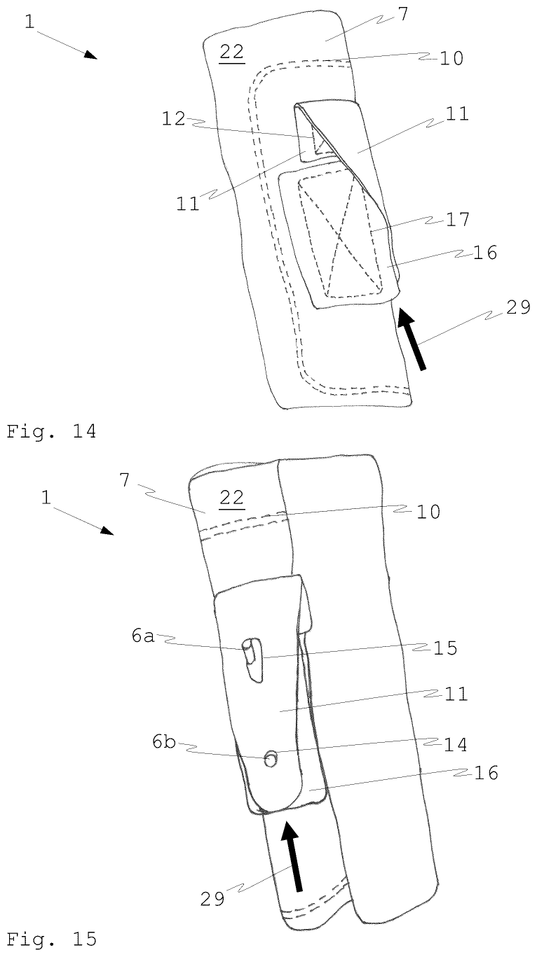

FIG. 5 shows a front perspective illustration of the airbag module according to the invention in the folded state with an inserted gas generator 2. In this case, only the connecting layer 16 is partially looped in the longitudinal direction over the gas generator 2, so that the fastening bolts 6a, 6b are arranged in the bolt passage openings 18a, 18b of the connecting layer 16. The tubular gas generator 2 is then rotated about its longitudinal axis so that the connecting layer 16 is clamped. Only then is the securing tab 11 folded over the gas generator 2 in the longitudinal direction, so that the fastening bolt 6a arranged closer to the gas generator inlet opening 8 is arranged in the securing opening 14 of the securing tab 11. The securing tab 11 is folded around the folding edge 30 explained with respect to the FIG. 2. In the process, according to the above explanations, the gas generator 2 is to be introduced into the airbag 1 in the direction of the securing tab 11, i.e., in the present case from the top downward, as a result of which the plug access 29 is also established, also see FIG. 6, FIG. 9, FIG. 10, FIG. 12, FIG. 13, FIG. 14 and FIG. 15.

FIG. 6 shows a rear perspective illustration of the airbag module according to the invention in the folded state with an inserted gas generator 2. It is clearly apparent how the fastening bolts 6a, 6b and the securing opening 14 as well as the bolt passage openings 18a, 18b of the connecting layer 16 lie on a sectional plane of the gas generator 2.

FIG. 7 shows a front view of another embodiment of the airbag module according to the invention in the unfolded state without an inserted gas generator 2. In this case, in contrast to the embodiment illustrated in FIG. 2, it is apparent that the connecting layer 16 and the securing tab 11 are significantly longer, with the bolt passage openings 18a, 18b and the securing opening 14 lying along an auxiliary line 24, which is offset with respect to the longitudinal axis 3 of the gas generator 2. In detail, in this embodiment, the securing tab 11 is oblique or L-shaped in such a way that an arrangement of the securing opening 14 on the fastening bolt 6b further away from the gas generator inlet opening 8 is possible, with the slope or the L-shape of the closer fastening bolt 6a not coming into contact with the securing tab 11.

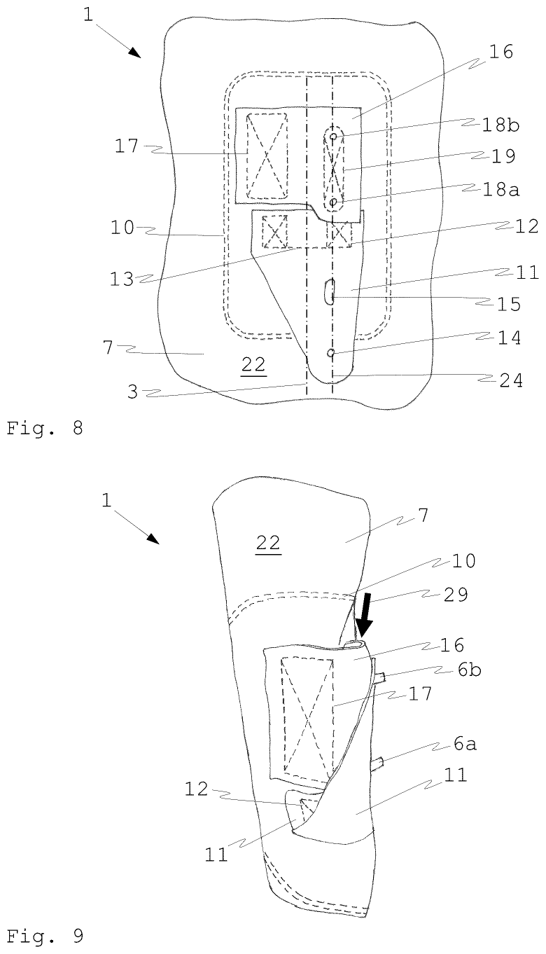

FIG. 8, on the other hand, shows an embodiment in which the securing tab 11 is triangular, with the securing tab 11 comprising, in addition to the securing opening 14 provided for arrangement of the further away fastening bolt 6b, a securing slot 15, in which the closer fastening bolt 6a can be arranged.

By means of such a configuration of the connecting layer 16 and the securing tab 11 according to FIG. 7 and FIG. 8, i.e., L-shaped as well as triangular, rotation of the gas generator 2 at least partially arranged in the airbag 1 is possible, specifically to an extent such that the connecting layer 16 is tensioned. In detail, a 90 degree rotation of the gas generator 2 can be realized, as a result of which use of the airbag module according to the invention in other regions of a vehicle interior is ensured.

FIG. 9 shows a front perspective illustration of the embodiment according to the invention according to FIG. 7 of the airbag module according to the invention in the folded state with an inserted gas generator 2. It is clearly evident here that, in contrast to FIG. 5 and FIG. 6, the fastening bolts 6 a, 6 b are rotated by 90 degrees with respect to the airbag module.

FIG. 10 shows a rear perspective illustration of the embodiment according to the invention according to FIG. 7 and FIG. 9 of the airbag module according to the invention in the folded state with an inserted gas generator 2. It is shown that the securing tab 11 is oblique and long or L-shaped in such a way that the securing opening 14 is arranged on the fastening bolt 6b further away from the gas generator inlet opening 8, while the closer fastening bolt 6a does not come into contact with the securing tab 11.

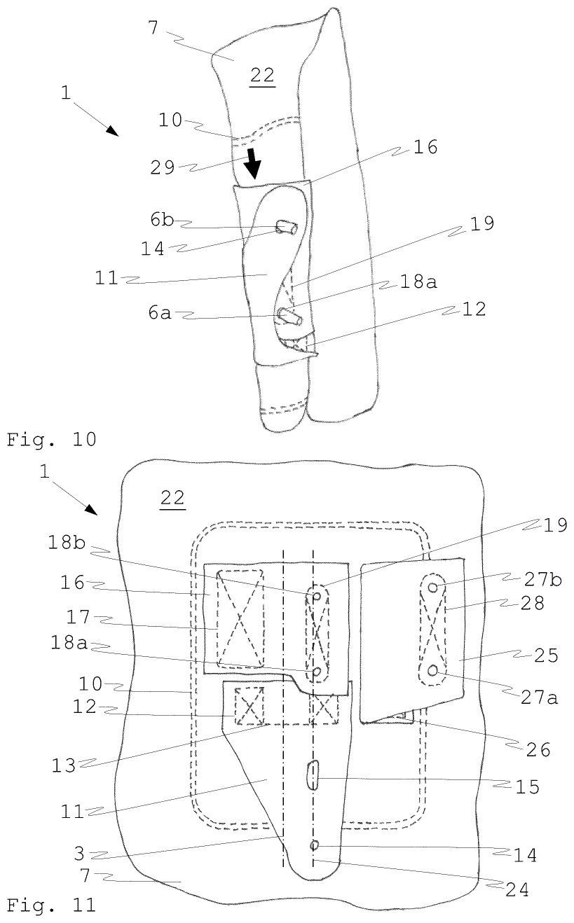

FIG. 11 shows a front view of another embodiment of the airbag module according to the invention in the unfolded state without an inserted gas generator 2. In contrast to the embodiment illustrated in FIG. 8, it is apparent here that an additional connecting layer 25 is arranged on the outer wall surface 22 of the airbag wall 7 by means of an additional connecting seam 26, the additional connecting layer 25 as per the connecting layer 16 comprising two additional bolt passage openings 27a, 27b and an additional fastening bolt seam 28. With the aid of this additional connecting layer 25, which at least partially encloses the securing tab 11, increased load absorption is ensured in the event of deployment of the airbag module.

FIG. 12 shows a front perspective illustration of the embodiment according to the invention of the airbag module according to the invention according to FIG. 11 in the folded state with an inserted gas generator 2, the additional connecting layer 25 at least partially enclosing the securing tab 11.

FIG. 13 shows a rear perspective illustration of the embodiment according to the invention of the airbag module according to the invention according to FIG. 11 in the folded state with an inserted gas generator 2. It is apparent here that the two fastening bolts 6a, 6b are inserted into the two additional bolt passage openings 27a, 27b of the additional connecting layer 25, the additional bolt passage openings 27a, 27b of the additional connecting layer 25 being reinforced by means of the additional fastening bolt seam 28.

FIG. 14 shows a front perspective illustration of another embodiment according to the invention of the airbag module according to the invention in the folded state with an inserted gas generator 2. In this embodiment, however, the gas generator 2 is to be introduced into the airbag 1 in an opposite direction to the above embodiments, as a result of which the plug access 29 also extends in reverse, i.e., in the present case from the bottom upward. It follows from this that the securing tab 11 arranged on the outer wall surface 22 of the airbag wall 7 of the airbag 1 by means of the securing seam 12 is also arranged in reverse, i.e., above, with respect to the connecting layer 16 arranged on the outer wall surface 22 of the airbag wall 7 of the airbag 1 by means of the connecting seam 17.

FIG. 15 shows a rear perspective illustration of the embodiment according to the invention of the airbag module according to the invention according to FIG. 14 in the folded state with an inserted gas generator 2. It is apparent here that the securing tab 11 is formed as per FIG. 8, i.e., is triangular. It is also apparent that, accordingly, the securing slot 15 of the securing tab 11 arranged above the connecting layer 16 loosely wraps around the fastening bolt 6a to be assigned thereto, whereas the securing opening 14 tightly wraps around the fastening bolt 6b, which is associated therewith and is arranged closer to the plug access 29, so that the securing tab 11 is supported primarily by means of the securing opening 14 in the event of deployment of the airbag module. LIST OF REFERENCE SIGNS
1 Airbag;
2 Tubular gas generator;
3 Longitudinal axis of the tubular gas generator 2;
4 Gas generator outlet;
5 Clamp;
6 a, b Fastening bolts;
7 Airbag wall;
8 Gas generator inlet opening;
9 Reinforcing layer;
10 Reinforcing seam;
11 Securing tab;
12 Securing seam;
13 Connecting web of the securing seam 12;
14 Securing opening;
15 Securing slot;
16 Connecting layer;
17 Connecting seam;
18 a, b Bolt passage opening of the connecting layer 16;
19 Fastening bolt seam of the connecting layer 16;
20 Flame retardant layer;
21 Sealing region;
22 Outer wall surface;
23 Inner wall surface;
24 Auxiliary line;
25 Additional connecting layer;
26 Additional connecting seam;
27 a, b Auxiliary bolt passage opening of the auxiliary connecting layer 25;
28 Additional fastening bolt seam of the additional connecting layer 25;
29 Plug access;
30 Folding line.

1. An airbag module, comprising:
an airbag; and
at least one tubular gas generator having a longitudinal axis,
wherein at least one fastening bolt for positioning the airbag module on a vehicle component is arranged on the at least one tubular gas generator,
the airbag comprising at least one airbag wall, wherein the at least one airbag wall forms a self-contained space for receiving gas and comprises an inner wall surface and an outer wall surface,
wherein the at least one airbag wall comprises at least one gas generator inlet opening and at least one securing tab,
wherein the at least one securing tab comprises at least one securing opening for securing the securing tab to the at least one fastening bolt,
the at least one tubular gas generator being at least partially inserted into the airbag via the gas generator inlet opening in such a way that at least one gas generator outlet of the tubular gas generator protrudes into the airbag so that, in an accident situation, the airbag is inflatable by means of a gas flowing out of the tubular gas generator,
wherein the securing tab is at least partially folded transversely or obliquely to the longitudinal axis of the at least one tubular gas generator and in a direction of the at least one fastening bolt connected to the tubular gas generator, and is secured by the at least one securing opening to the at least one fastening bolt.

2. The airbag module as claimed in claim 1, wherein the securing tab is arranged on the outer wall surface of the airbag wall by a securing seam and/or an adhesive connection.

3. The airbag module as claimed in claim 2, wherein the securing tab is elongated and tongue-shaped, with the at least one securing opening being arranged opposite the securing seam and/or the adhesive connection.

4. The airbag module as claimed in claim 1, wherein the airbag wall comprises at least one flame retardant layer on the inner wall surface in a region of the gas generator inlet opening.

5. The airbag module as claimed in claim 4, wherein the flame retardant layer is arranged on the inner wall surface of the airbag wall by a securing seam and/or by an adhesive connection.

6. The airbag module as claimed in claim 1, wherein the airbag wall comprises at least one connecting layer on the outer wall surface, the connecting layer at least partially covering the tubular gas generator when the tubular gas generator is inserted in the gas generator inlet opening.

7. The airbag module as claimed in claim 6, wherein the connecting layer can be arranged on the outer wall surface of the airbag wall by a connecting seam and/or an adhesive connection.

8. The airbag module as claimed in claim 7, wherein the connecting seam and/or the adhesive connection are/is offset with respect to a longitudinal axis of the tubular gas generator.

9. The airbag module as claimed in claim 6, wherein the connecting layer comprises at least one bolt passage opening for receiving the at least one fastening bolt in an inserted state of the tubular gas generator in the gas generator inlet opening.

10. The airbag module as claimed in claim 1, wherein, in a region of the gas generator inlet opening, the airbag wall comprises at least one reinforcing layer that is arranged on the inner wall surface and/or outer wall surface, the reinforcing layer being arranged on the airbag wall by least one reinforcing seam and/or an adhesive connection.

11. The airbag module as claimed in claim 1, wherein a sealing region is formed in a region of the gas generator inlet opening, in an inserted state of the tubular gas generator, by means of the outer wall surface of the airbag wall and the securing tab.

12. The airbag module as claimed in claim 1, wherein the tubular gas generator comprises a first fastening bolt and a second fastening bolt, the first fastening bolt being arranged closer to the gas generator inlet opening than the second fastening bolt.

13. The airbag module as claimed in claim 12, wherein the securing tab is configured such that the securing opening can be arranged on the first fastening bolt.

14. The airbag module as claimed in claim 12, wherein the securing tab is elongated obliquely or L-shaped, in such a way that the securing opening can be positioned on the second fastening bolt.

15. The airbag module as claimed in claim 12, wherein the securing tab comprises two securing openings or one securing opening and one securing slot, which are configured to be arranged on one of the first and second fastening bolts.

16. The airbag module as claimed in claim 1, wherein a sealing means for producing a gas-tight connection is arranged along a reinforcing seam between a reinforcing layer and the airbag wall and/or along a securing seam between the securing tab and the airbag wall and/or along the connecting seam between the connecting layer and the airbag wall.

17. The airbag module as claimed in claim 1, wherein the airbag wall comprises, on the outer wall surface, at least one additional connecting layer that is arranged along the longitudinal axis of the tubular gas generator parallel to the connecting layer, the additional connecting layer being arranged on the outer wall surface of the airbag wall by an additional connecting seam and/or an adhesive connection, and the additional connecting layer at least partially covering the securing tab in an inserted state of the tubular gas generator in the gas generator inlet opening.

18. The airbag module as claimed in claim 17, wherein the additional connecting layer comprises at least one additional bolt passage opening for receiving the at least one fastening bolt in the inserted state of the tubular gas generator in the gas generator inlet opening.

19. The airbag module as claimed in claim 1, wherein the gas generator inlet opening is at least partially covered by the securing tab in an uninserted state of the tubular gas generator.

20. An airbag for an airbag module that comprises the airbag and at least one tubular gas generator having a longitudinal axis and at least one fastening bolt,
the airbag comprising:
at least one airbag wall, wherein the at least one airbag wall forms a self-contained space for receiving gas and comprises an inner wall surface and an outer wall surface,
wherein the airbag wall comprises at least one gas generator inlet opening and at least one securing tab,
wherein the at least one securing tab comprises at least one securing opening for securing the securing tab to a fastening bolt of the at least one tubular gas generator,
wherein the gas generator inlet opening is configured such that a tubular gas generator can be at least partially inserted into the airbag via the gas generator inlet opening such that at least one gas generator outlet of the tubular gas generator protrudes into the airbag,
wherein, in an accident situation, the airbag is inflatable by a gas flowing out of the tubular gas generator,
wherein the securing tab is configured and arranged such that the securing tab can be at least partially folded transversely or obliquely to the longitudinal axis of a tubular gas generator inserted into the gas generator inlet opening and in a direction of at least one fastening bolt connected to the tubular gas generator, and can be secured by the at least one securing opening to at least one of the at least one fastening bolt.
